(19) United States
(12) Patent Application Publication
(10) Pub. No.: US 2016/0180352 A1
(43) Pub. Date: Jun. 23, 2016

(54) System Detecting and Mitigating Frustration of Software User

(71) Applicants: Qing Chen, Coquitlam (CA); Rajpaul Grewal, Richmond (CA); Juo Nung Shih, San Francisco, CA (US); Brett Wakefield, Maple Ridge (CA); Chee Wong, Vancouver (CA); Jie Yu, Port Moody (CA)

(72) Inventors: Qing Chen, Coquitlam (CA); Rajpaul Grewal, Richmond (CA); Juo Nung Shih, San Francisco, CA (US); Brett Wakefield, Maple Ridge (CA); Chee Wong, Vancouver (CA); Jie Yu, Port Moody (CA)

(21) Appl. No.: 14/573,056

(22) Filed: Dec. 17, 2014

(51) Int. Cl. G06Q 30/02; G06Q 30/00; G06F 17/30

(52) U.S. Cl. CPC G06Q 30/0201; G06F 17/3053; G06F 17/30887; G06F 17/30914; G06Q 30/016

(57) ABSTRACT

A software frustration detection system interposed between software and a user, receives interactions indicative of user frustration (e.g., a user accessing in-product help, a user performing a sequence of actions but not clicking “submit”, a user canceling operations, etc.). Due to privacy concerns, the system may not gain access to substantive data of the interaction. Based upon characteristics of detected interaction(s), the system is configured calculate a frustration score, and then provide user support based upon that score. In particular, a support subsystem may locate various possible sources of support (e.g., user blogs, demonstrations, IT department contact), connect to those support services, and then provide appropriate support to a user. The system may operate in an iterative manner, with increasing frustration revealed by subsequent user actions, being met with an escalating intensity of support provided. Certain embodiments may operate based upon active user feedback to the provided support.

### BACKGROUND

The present invention relates to computer software, and in particular, to system and methods that detect and/or mitigate frustration experienced by a user interacting with a software product.

Unless otherwise indicated herein, the approaches described in this section are not prior art to the claims in this application and are not admitted to be prior art by inclusion in this section.

Computers play an ever-increasing role in almost every conceivable human activity. Common to most computer applications is the presence of a software interface allowing interaction between the computer and a human being. Such software has become extremely complex, often offering a bewildering selection of view screens, possible inputs, and expected outputs, to the user.

Traditionally, human satisfaction with software operation has been recorded utilizing techniques such as focus groups and user surveys. However, such approaches are labor intensive and costly.

Moreover, such conventional approaches are typically after-the-fact, occurring only once a user has already experienced a significant amount of frustration and dissatisfaction. Such a visceral reaction can have adverse consequences for a customer's future use of a software product (including improved versions of the software).

### SUMMARY

A software frustration detection system is interposed between software (e.g., hosted on a remote server) and a user (accessing the software via a client). The system is configured to receive interactions evidencing user frustration (e.g., the user accessing in-product help, the user performing a sequence of actions but not clicking “submit”, the user canceling operations, etc.)

Due to privacy concerns, these interactions may be received without the system gaining access to the substantive (and potentially confidential) content of the interaction. Thus, while the system may detect an interaction in the form of a user's unsuccessful attempted entry of data into the software, the system may not also have access to that underlying data itself.

Based upon one or more such detected interactions, the system is configured calculate a frustration score, and then prepare a response based upon that score. In particular, a support subsystem is configured to locate various possible sources of support (e.g., user blogs, demos, IT department contact), connect to those support services, and then provide the support to a user.

The system may operate in an iterative manner, with increasing frustration revealed by subsequent user actions, met with an escalating intensity of provided support. Certain embodiments may operate based upon active user feedback to the support provided.

An embodiment of a computer-implemented method comprises a first engine detecting an interaction between a software product and the user. The first engine calculates a frustration score based upon a characteristic of the interaction. The first engine communicates the frustration score in order to provide support to the user.

In certain embodiments the characteristic comprises a response time, canceling an action, an invalid data entry, or a help request.

Particular embodiments may further comprise a second engine receiving the frustration score, and the second engine providing the support according to an intensity based on the frustration score.

In some embodiments a highest intensity comprises a contact from a human support specialist.

In various embodiments the second engine provides the support based upon content received from a content locator.

Certain embodiments may further comprise the content locator examining a mapping of a user interface from URL to the content.

According to some embodiments the user interface comprises a form.

In various embodiments the content comprises feedback and the method further comprises the first engine detecting a subsequent interaction between the software product and the user. The first engine calculates a new frustration score based upon a characteristic of the subsequent interaction. The first engine communicates the new frustration score to the second engine. The second engine provides updated support according to an intensity based on the new frustration score and the feedback.

According to particular embodiments the interaction comprises an entry of data, but the data is not provided to the first engine.

An example of a non-transitory computer readable storage medium embodies a computer program for performing a method comprising, a first engine detecting an interaction between a software product and the user. The first engine calculates a frustration score based upon a characteristic of the interaction comprising a response time, canceling an action, an invalid data entry, or a help request. The first engine communicates the frustration score to a second engine. The second engine provides user support according to an intensity based on the frustration score.

An embodiment of a computer system comprises one or more processors and a software program executable on said computer system. The software program is configured to cause a first engine to detect an interaction between a software product and the user. The software program is configured to cause the first engine to calculate a frustration score based upon a characteristic of the interaction comprising a response time, canceling an action, an invalid data entry, or a help request. The software program is configured to cause the first engine communicate the frustration score to a second engine. The software program is configured to cause the second engine to receive feedback. The second engine provides user support according to an intensity based on the frustration score and the feedback.

The following detailed description and accompanying drawings provide a better understanding of the nature and advantages of the present invention.

### BRIEF DESCRIPTION OF THE DRAWINGS

FIG. 1 illustrates a simplified view of a system configured to detect and/or mitigate software user frustration according to an embodiment.

FIG. 2 is a simplified diagram illustrating a process flow according to an embodiment.

FIG. 3 illustrates a detailed view of a system according to an embodiment.

FIG. 4 shows a simplified view of an example of a form which may be employed to collect user interaction data.

FIG. 5 illustrates hardware of a special purpose computing machine configured to implement software user frustration detection and/or mitigation according to an embodiment.

FIG. 6 illustrates an example of a computer system.

### DETAILED DESCRIPTION

Described herein are techniques for detecting and/or mitigating frustration of a user with a software product. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

A software frustration detection system is interposed between software and a user. The system is configured to receive interactions evidencing user frustration (e.g., the user accessing in-product help, the user performing a sequence of actions but not clicking “submit”, the user canceling operations, etc.) Out of privacy concerns, this typically occurs without the system gaining access to the actual substantive data of the underlying interaction (e.g., the information entered by a user).

Based upon one or more such detected interactions, the system is configured to calculate a frustration score, and then prepare a response based upon that score. In particular, a support subsystem is configured to locate various possible sources of support (e.g., user blogs, demonstrations, IT department contact), connect to those support services, and then provide the support to a user. The system may operate in an iterative manner, with increasing frustration revealed by subsequent user actions, met with an escalating intensity of provided support. Certain embodiments may operate based upon active user feedback to the support provided.

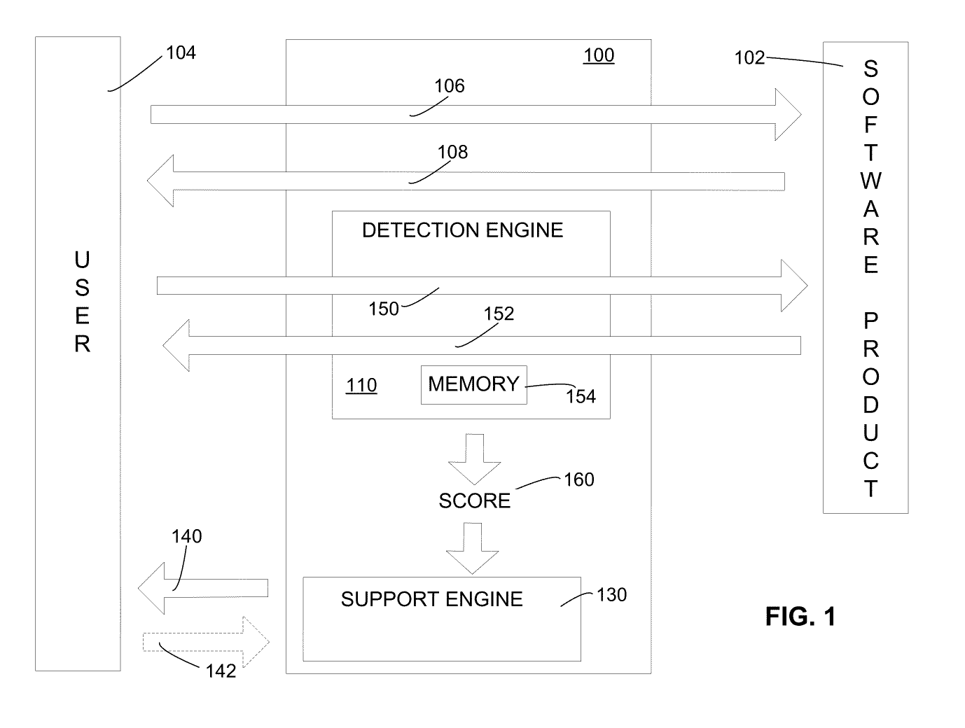

FIG. 1 shows a simplified view of an embodiment of a system 100 for implementing software user frustration detection and/or mitigation. In particular, the system is interposed between a software product 102, and a user 104 of that software product.

Interactions between the user and the software can take two forms. One is an interaction 106 communicating information from a user to the software product. Some such interactions can involve the transmittal of content—e.g., specific data which may be private in nature. Other such interactions may not include substantive data—e.g., the user canceling an action, or selecting a particular option offered by the software product.

Another form of interaction 108 comprises the software product communicating information to the user. This interaction can comprise a message having substantive content—e.g., communicating specific information relevant to a user inquiry. Other such interactions may not include substantive content—e.g., the software displaying a message denying acceptance of a user's attempted action.

A detection engine 110 of the software user frustration detection/mitigation system, is configured to receive certain types of interactions 150, 152 between the user and the software product. In particular, these interactions are specifically designated as being indicative of instances of user frustration.

Examples of such interactions can include but are not limited to:

a user accessing an in-product help functionality;

a user performing a sequence of actions without ultimately clicking “submit”;

a user canceling an in-progress operation; and

a user entering an invalid entry into a field.

Other information relating to the relationship between different interactions, may be collected and referenced by the detection engine 110. For example, the detection engine 110 may detect a time taken by the product to respond to requests.

Under some circumstances, a short response time by the software product may indicate rejection invalid information attempted to be entered by a user. This invalid information is not even able to be recognized by the software. Such an event can reveal user frustration.

Under other circumstances, a long response time by the software product may also indicate user frustration. That is, a user having to wait for a response may in and of itself generate frustration.

Also, long response times may reveal that the user is providing input in an inefficient/unexpected manner for processing by the software product. Again, this can be indicative of frustration.

A time taken by a user to respond to requests from the software product may also evidence frustration. For example, the user may become confused and frustrated, and not know how to provide input to the software product. Thus a long delay may indicate frustration.

Similarly, many software users may vent frustration by rapidly hitting a key or mouse button. Such instinctive activity can be sensed by the system as evidence of frustration.

Once interaction(s) characteristic of user frustration have been detected, the system may take specific action(s) appropriate to mitigate this frustration. In particular, the detection engine 110 may calculate a numerical frustration score 160 and store that frustration score within a memory 154. That score may in turn be communicated to a support engine 130.

Upon receipt of the score, the support engine may determine a support to be provided to the user. Such support can take various levels of intensity, ranging from an automated help in-program help function, all the way to personal contact with a human member of the software product's support team. Support of an intermediate level of intensity can comprise providing access to work groups, user blogs, and/or manuals (e.g., via online searching).

The appropriate level of support 140 is then provided from the system to the user.

In response, the user can optionally provide feedback 142 to the system regarding a helpfulness of the support provided. This feedback can in turn provide the system with more information to consider in preparing a response to subsequent interactions indicative of user frustration.

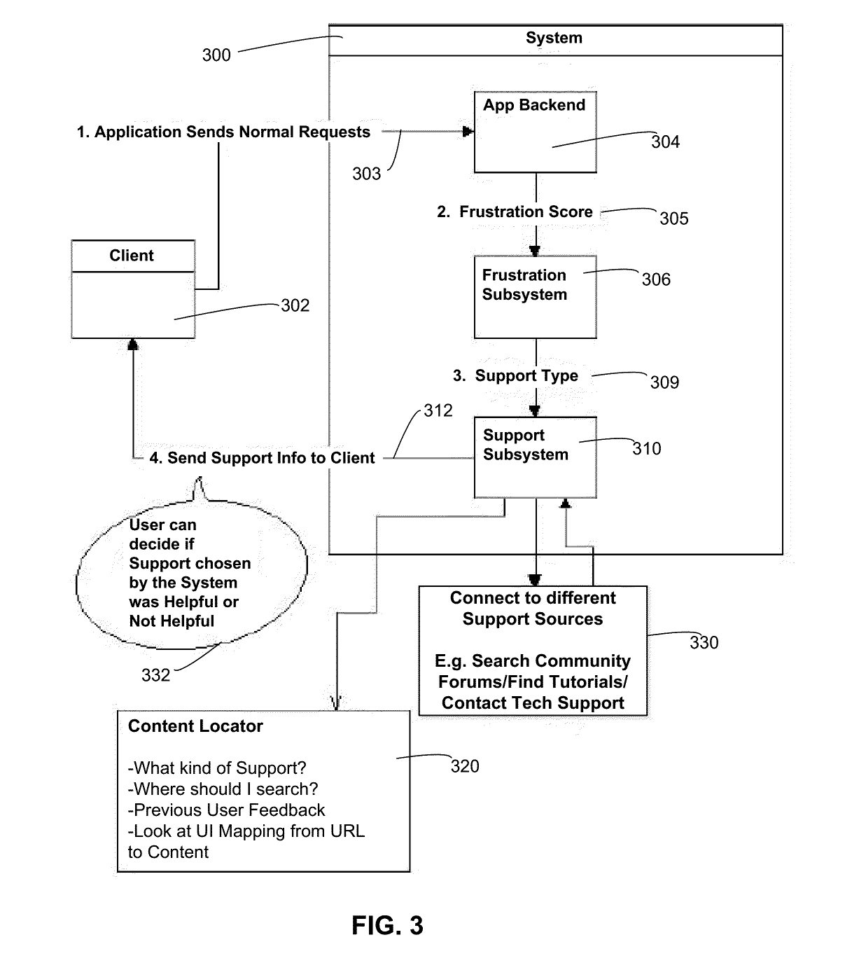

Further details regarding one particular implementation of a software detection and/or mitigation system are provided in connection with FIG. 3.

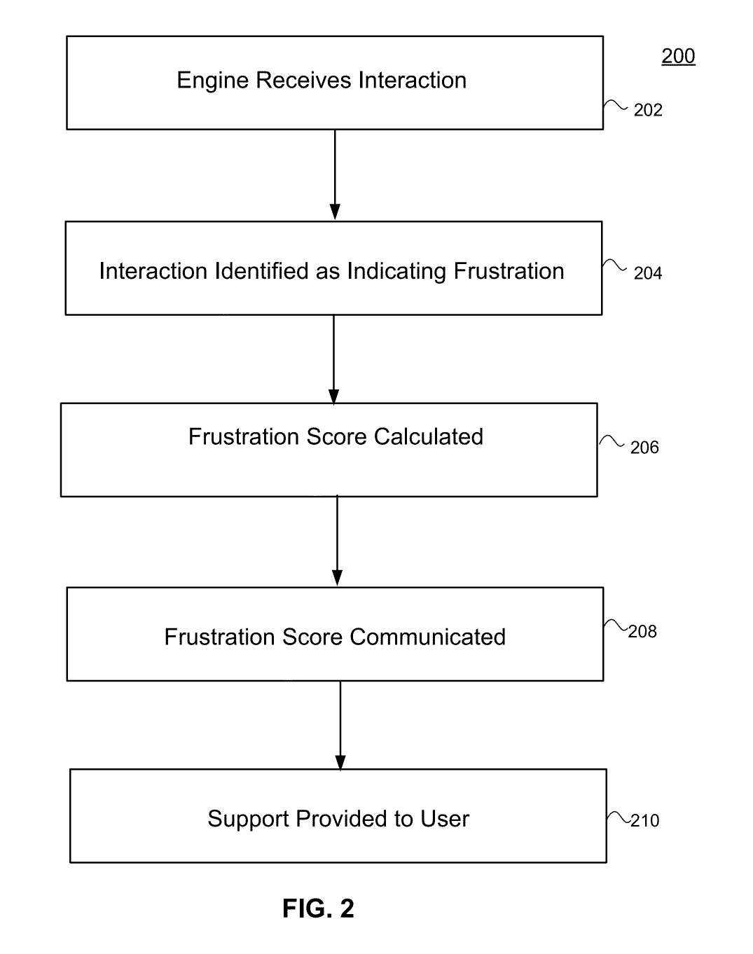

FIG. 2 is a simplified flow diagram illustrating a process 200 according to an embodiment. In first step 202, a first engine detects an interaction between a software product and a user.

In a second step 204, the first engine determines that the interaction is indicative of user frustration. This determination may be made through recognition of particular characteristics of the interaction, followed by reference to a Look Up Table (LUT) or other mechanism.

In a third step 206, the first engine calculates a frustration score associated with the user based upon characteristics of the detected interaction. In a fourth step 208, the first engine communicates the frustration score to a second engine.

In fifth step 210, based upon this frustration score the second engine provides an appropriate level of support to the user.

### EXAMPLE

According to embodiments, a software user frustration detection and mitigation system detects when the user of a software system is “frustrated”. Frustration is defined as having difficulties understanding how to use a software system and to perform appropriate tasks.

When the system detects frustration, it determines what kind of support is appropriate for the user and provides that support to the user. The system continues to monitor the user's frustration level.

If the frustration does not exhibit a decrease, different types of support may then be offered to the user. This offer of additional support may take the form of a feedback loop.

FIG. 3 shows a simplified workflow of operation of a system 300 as an example implemented in a web application/server. Here, the user communicates via client 302 with the system, to send normal requests 303 to a backend 304.

The application backend receives the interaction data from the user. In certain embodiments the frustration detection and/or mitigation system will collect the user information according to event driven programing. Such event driven programming is a popular paradigm for user interface implementation.

One particular implementation of data collection according to event driven programming is given below:

FrustrationIndex FI = new FrustrationIndex( );
Button helpButton = new Button( );
helpButton.AddListner( function( ) {

FI.UserAccessedHelp( “HelpButton” );

});

The application thus specifically notes when the user performs actions indicating that the user is having difficulties understanding or performing his or her objective(s) with the software product. Here, the user's accessing a help button is logged as an interaction indicative of frustration. Other possible actions can include but are not limited to:

a time it takes the product to respond to requests;

customer performs sequence of actions but doesn't click “submit”;

a number of times a user cancels an operation; and

the user entering an invalid entry into a field.

Various interaction metrics may be tracked in order to detect user frustration. Tracked metrics can include but are not limited to a number of clicks, a number of page visits, website response time, etc.

Data may be collected at the application backend utilizing specialized analytics-like software, for example as available from Google, Inc. Interaction data may also be available through a Content Management System (CMS) auditing database.

Still further alternatively, data may be collected by recording HTTP traffic through web application filters. Other approaches to gathering interaction information may involve the addition of a unique identifier (ID) to buttons and links in the software product.

Based upon this recorded interaction data, the application backend ultimately compiles a frustration score 305. One example of a formula for calculating this frustration score is given by the following equation.

Frustration score=(Pr+Qh+Rc+Si)/t, where:
r=a time taken by the product to respond to operation requests;
h=a number of times the user accesses in-product help;
c=a number of times a user cancels an operation;
i=a number of times the user enters an invalid entry;
t=an amount of time the product was used; and
P, Q, R, S=constants selected to afford weight to the above factors.

As shown in FIG. 3, this frustration score is then passed from the application backend to the frustration subsystem 306. The frustration subsystem tracks the user's frustration, and how that frustration is changing according to support being provided. The frustration subsystem determines if the current frustration score is above the acceptable threshold.

If frustration is above a threshold, the frustration subsystem communicates a support type 309 to the support subsystem 310. In particular, the support type that is passed, serves as a basis for the support information 312 ultimately provided to the user (e.g., via the client).

For example, if the score is above the acceptable threshold for a first time for a given webpage, the “Support Type” may be at a low level of intensity. If, however, the frustration score is above the acceptable threshold and support was previously provided to the user for the given webpage, then an intensity of the support type can be increased.

The “Support Subsystem” connects the user with support in order to help mitigate the frustration. When the Support System receives the Support Type from the Frustration Subsystem, it determines what kind of support the user should receive.

In the specific example of FIG. 3, this may be done by matching the Support Type for the given page with its catalog of support via the “Content Locator” 320.

This catalog may offer support in various forms. Examples include but are not limited to tutorials, community forums, and live contact with a human staff member of the technical support team.

In performing its duties, the content locator may perform various actions. For example, it may reference the catalog to identify the various forms of support that are available.

The content locator may also search to investigate possible support services that are available for a particular source of frustration (e.g., web blogs, user forums). The content locator may also reference feedback previously received from the instant user, or from other users.

The content locator may examine a mapping of the user interface from URL to content. That is, a specific web page accessed by the client and on which a user is experiencing frustration, may provide relevant context for the support ultimately supplied by the system.

In the particular embodiment of the example of FIG. 3, the content locator is located outside of the system. This reflects the possible utilization of the content locator for purposes other than mitigating frustration of a user with a software product. For example, the content locator could be relied upon by other systems to perform web searching, etc.

Based upon content located by the content locator, the frustration subsystem may in turn reach out to various support sources 330. These support sources can include but are not limited to the following, which are listed below according to an approximate order of increasing intensity and/or specificity:

in-product help functionality;

available software product documentation (e.g., manuals, cheat sheets, etc.);

on-line tutorials;

demos;

community forums;

human technical support (e.g., IT department).

Once the appropriate form of support is determined with reference to the content locator and support sources, an appropriate level of intensity of support is provided to the user at the client. The user can then decide if the support chosen by the system was helpful or not helpful, providing relevant feedback 332 to the system.

As indicated above, frustration with software is detected by collecting data in the form of user interactions. By recording data of these interactions (e.g., in a database), a frequency of user frustration may be determined.

A variety of user interactions may be recorded to serve as a basis for determining a frustration level. Examples of user interactions available for this purpose include but are not limited to:

a time it takes the product to respond to requests;

a number of times the user access in-product help;

customer performs sequence of actions but doesn't click “submit”;

a number of times a user cancels an operation; and

the user entering an invalid entry into a field.

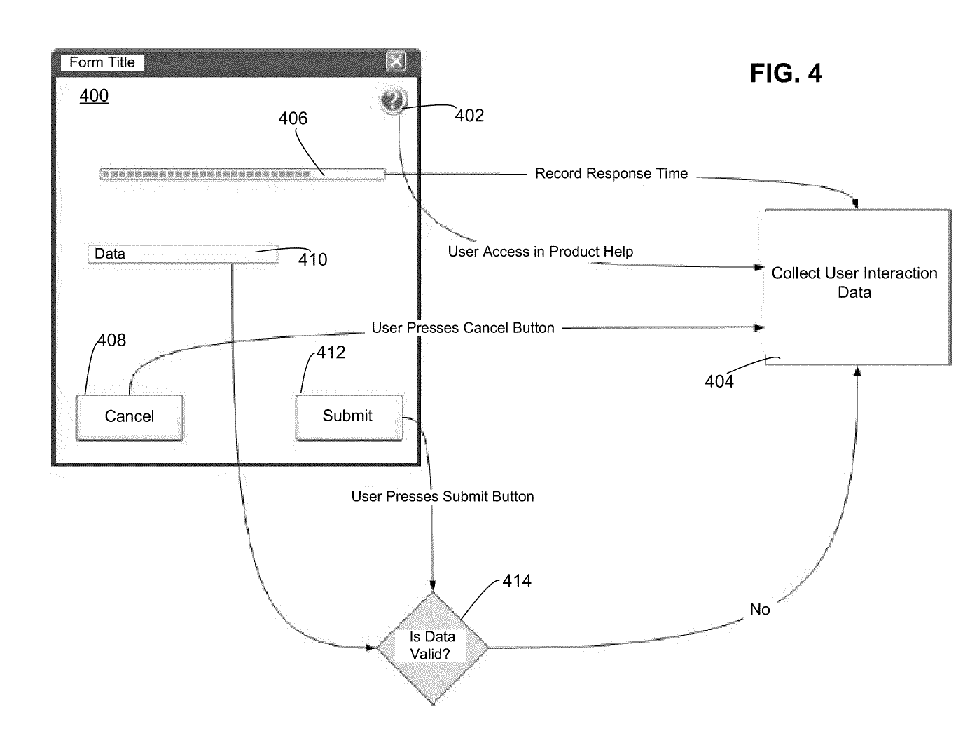

FIG. 4 shows a simplified view of an example of a form which may be employed to collect user interaction data useful in detecting and/or mitigating frustration of a software user. In this particular example, the form 400 comprises a help button 402, interaction with which may allow a system 404 to collect user data revealing the user seeking help from an in-product help functionality.

The form 400 may also comprise a progress bar 406. Data from this element may allow the system to record a time taken by the user to respond to the software product.

The form 400 may further comprise a cancel button 408. This element may provide may allow the system to recognize the user canceling an operation—an act potentially indicative of frustration. It is noted that the actual data attempted to be entered may not be intercepted by the user frustration detection/mitigation system, thereby avoiding concerns of privacy.

The form 400 may further comprise a data entry field 410 and a submit button 412. User interaction with either of these elements may prompt the software product to communicate a message 414 of invalid data. Again, such a message may be indicative of user frustration.

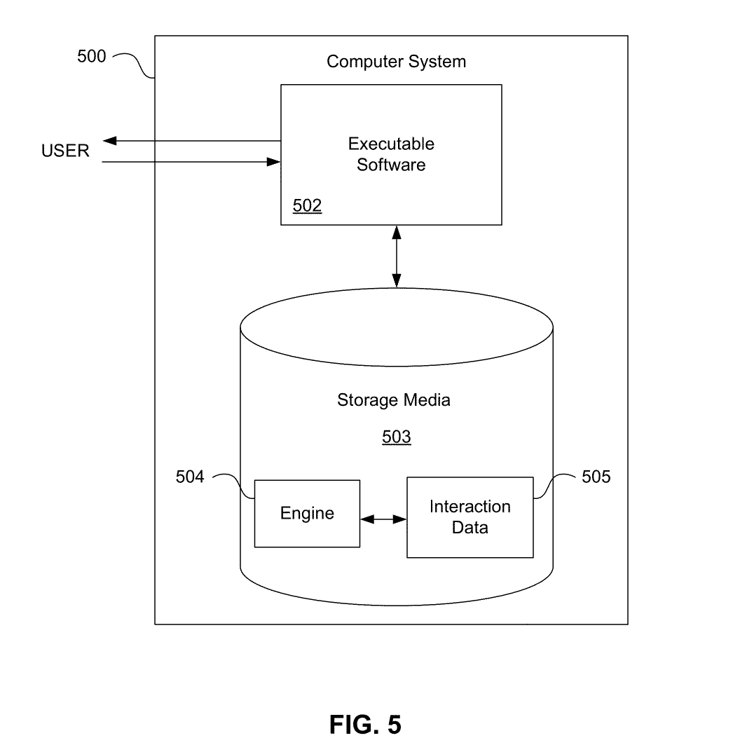

FIG. 5 illustrates hardware of a special purpose computing machine configured to detect and/or mitigate frustration of a user with a software product. In particular, computer system 500 comprises a processor 502 that is in electronic communication with a non-transitory computer-readable storage medium 503. This computer-readable storage medium has stored thereon code 505 corresponding to interaction data. Code 504 corresponds to an engine. Code may be configured to reference data stored in a database of a non-transitory computer-readable storage medium, for example as may be present locally or in a remote database server. Software servers together may form a cluster or logical network of computer systems programmed with software programs that communicate with each other and work together in order to process requests.

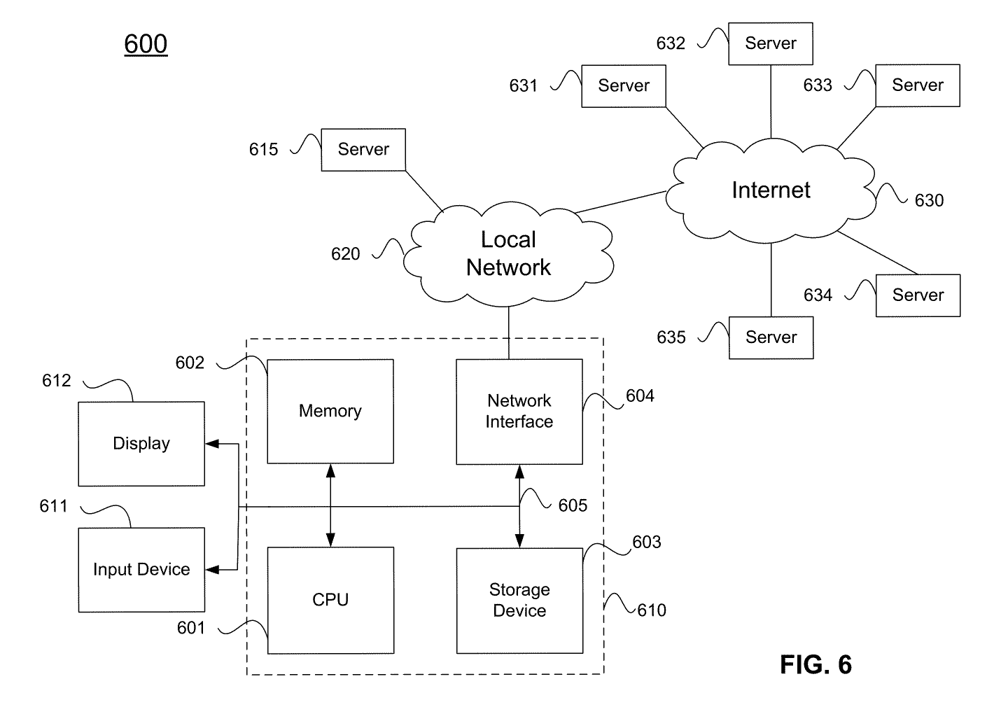

An example computer system 610 is illustrated in FIG. 6. Computer system 610 includes a bus 605 or other communication mechanism for communicating information, and a processor 601 coupled with bus 605 for processing information. Computer system 610 also includes a memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 603 may include source code, binary code, or software files for performing the techniques above, for example. Storage device and memory are both examples of computer readable mediums.

Computer system 610 may be coupled via bus 605 to a display 612, such as a cathode ray tube (CRT) or liquid crystal display (LCD), for displaying information to a computer user. An input device 611 such as a keyboard and/or mouse is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 604 sends and receives electrical, electromagnetic, or optical signals that carry digital data streams representing various types of information.

Computer system 610 can send and receive information, including messages or other interface actions, through the network interface 604 across a local network 620, an Intranet, or the Internet 630. For a local network, computer system 610 may communicate with a plurality of other computer machines, such as server 615. Accordingly, computer system 610 and server computer systems represented by server 615 may form a cloud computing network, which may be programmed with processes described herein. In the Internet example, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method comprising:
a first engine detecting an interaction between a software product and the user;
the first engine calculating a frustration score based upon a characteristic of the interaction; and
the first engine communicating the frustration score in order to provide support to the user.

2. A method as in claim 1 wherein the characteristic comprises a response time, canceling an action, an invalid data entry, or a help request.

3. A method as in claim 1 further comprising:
a second engine receiving the frustration score; and
the second engine providing the support according to an intensity based on the frustration score.

4. A method as in claim 3 wherein a highest intensity comprises a contact from a human support specialist.

5. A method as in claim 3 wherein the second engine provides the support based upon content received from a content locator.

6. A method as in claim 5 further comprising the content locator examining a mapping of a user interface from URL to the content.

7. A method as in claim 6 wherein the user interface comprises a form.

8. A method as in claim 5 wherein the content comprises feedback, the method further comprising:
the first engine detecting a subsequent interaction between the software product and the user;
the first engine calculating a new frustration score based upon a characteristic of the subsequent interaction;
the first engine communicating the new frustration score to the second engine; and
the second engine providing updated support according to an intensity based on the new frustration score and the feedback.

9. A method as in claim 1 wherein the interaction comprises an entry of data, but the data is not provided to the first engine.

10. A non-transitory computer readable storage medium embodying a computer program for performing a method, said method comprising:
a first engine detecting an interaction between a software product and the user;
the first engine calculating a frustration score based upon a characteristic of the interaction comprising a response time, canceling an action, an invalid data entry, or a help request;
the first engine communicating the frustration score to a second engine; and
the second engine providing user support according to an intensity based on the frustration score.

11. A non-transitory computer readable storage medium as in claim 10 wherein the user support is selected from in-product help functionality, product documentation, a demo, a tutorial, a community forum, or a contact from a human support specialist.

12. A non-transitory computer readable storage medium as in claim 10 wherein the second engine provides the support based upon content received from a content locator.

13. A non-transitory computer readable storage medium as in claim 12 wherein the method further comprises the content locator examining a mapping of a user interface from URL to the content.

14. A non-transitory computer readable storage medium as in claim 13 wherein the user interface comprises a form.

15. A non-transitory computer readable storage medium as in claim 12 wherein the content comprises feedback, and the method further comprises:
the first engine detecting a subsequent interaction between the software product and the user;
the first engine calculating a new frustration score based upon a characteristic of the subsequent interaction;
the first engine communicating the new frustration score to the second engine; and
the second engine providing updated support according to an intensity based on the new frustration score and the feedback.

16. A computer system comprising:
one or more processors;
a software program, executable on said computer system, the software program configured to:
cause a first engine to detect an interaction between a software product and the user;
cause the first engine to calculate a frustration score based upon a characteristic of the interaction comprising a response time, canceling an action, an invalid data entry, or a help request;
cause the first engine communicate the frustration score to a second engine;
cause the second engine to receive feedback; and
the second engine providing user support according to an intensity based on the frustration score and the feedback.

17. A computer system as in claim 16 wherein the user support is selected from in-product help functionality, product documentation, a demo, a tutorial, a community forum, or a contact from a human support specialist.

18. A computer system as in claim 16 wherein the second engine provides the support based upon content received from a content locator.

19. A computer system as in claim 16 wherein the software program is further configured to cause the content locator to examine a mapping of a user interface from URL to the content.

20. A computer system as in claim 16 wherein the interaction comprises an entry of data, but the data is not provided to the first engine.
